(19) United States
(12) Patent Application Publication
(10) Pub. No.: US 2006/0168005 A1
(43) Pub. Date: Jul. 27, 2006

(54) Image forming apparatus using system and office supply information server

(76) Inventors: Kohji Kanbara, Tokyo (JP); Shinkichi Hashimoto, Tokyo (JP); Toshiyasu Takahashi, Tokyo (JP); Tetsufumi Haraguchi, Tokyo (JP); Yoshio Tominaga, Tokyo (JP); Naoki Sasahara, Tokyo (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/559,665

(22) PCT Filed: Jun. 3, 2004
(86) PCT No.: PCT/JP04/08057

§ 371 Date: Dec. 5, 2005

(30) Foreign Application Priority Data
Jun. 6, 2003 (JP) 2003162618
Apr. 20, 2004 (JP) 2004124319

(51) Int. Cl. G06F 15/16

(52) U.S. Cl. 709/206

(57) ABSTRACT

An image forming apparatus using system including at least one image forming apparatus having a touch panel and an office supply information server that is connected to the image forming apparatuses via a network is provided. The image forming apparatus includes: a part for sending order information to the office supply information server; and a part for receiving information from the office supply information server, the office supply information server includes: a server information sending part for sending information to the image forming apparatus; and a client information receiving part for receiving information input from the touch panel of the image forming apparatus, and the image forming apparatus orders an office supply from the office supply information server.

### TECHNICAL FIELD

The present invention relates to an image forming apparatus using system and an office supply information server.

### BACKGROUND ART

Supplies such as toner and copy papers used in an office requires replenishment on a day-to-day basis. Although the supplies are usually kept in stock in the user site, there are many cases where the user needs to place an order of the supplies after being aware of lack of the supplies. Some users periodically check the stock of the supplies so as to place an order of only consumed amount of the supplies.

The users place an order of the supplies (alternatively may be referred to as “consumable items”) in various ways. Some users call a selling company and tell a commodity name, amount, customer information and the like. Some users fill out an order form with a commodity name, amount, customer information and the like, and send the form to a selling company by facsimile. Others access a home page of a store on the Web and select some items and enter necessary data in the items by using a PC (personal computer).

However, when consumable items are used up, there may be a case where replenishment of the consumable items is delayed so that the consumable items cannot be replenished. In addition, as to the method of periodically checking the stock and ordering only consumed amount, there is a problem in that there is extra cost for managing the stock.

In addition, as to the ordering method for calling the selling company, there is a problem in that it takes much time to order since the user needs to check commodity names and sending addresses and the like. As to the ordering method for filling out an order form and sending the form by facsimile, there is a problem in that the user may erroneously fill out the form or the selling company may erroneously read the form. As to the ordering method by using the PC, there is a problem in that launch and operation of software take time so that it is not convenient for the user.

### DISCLOSURE OF THE INVENTION

An object of the present invention is to provide an image forming apparatus using system and an office supply information server for replenishing supplies timely.

The above object is achieved by an image forming apparatus using system including at least one image forming apparatus having a touch panel and an office supply information server that is connected to the image forming apparatuses via a network,

the image forming apparatus including:

a client information sending part for sending order information to the office supply information server; and

a server information receiving part for receiving information from the office supply information server,

the office supply information server including:

a server information sending part for sending information to the image forming apparatus; and

a client information receiving part for receiving information input from the touch panel of the image forming apparatus,

wherein the image forming apparatus orders an office supply from the office supply information server by using the client information sending part.

According to the present invention, an image forming apparatus using system and an office supply information server for replenishing supplies easily, correctly and timely can be provided.

In addition, according to the present invention, bi-directional communication between the office supply information server and the image forming apparatus can be realized, so that an order of office supplies can be placed directly from the image forming apparatus. Although the office supply may be items such as copy papers and stationary and the like that are mainly used in an office, the items are called as “office supplies” even when the items are used in a laboratory or in a factory and the like other than the “office”. On the other hand, a beaker or other equipment used mainly in the laboratory or in the factory is included in “office supply”.

Other objects, features and advantages of the present invention will become more apparent from the following detailed description when read in conjunction with the accompanying drawings.

### BRIEF DESCRIPTION OF THE DRAWINGS

FIG. 1 is a block diagram of an image forming apparatus using system of a first embodiment of the present invention;

FIG. 2A shows an example of stored information in a consumable item remaining number storing part;

FIG. 2B shows an example of a consumable item and an IC tag;

FIG. 3 shows a functional block diagram indicating functions of the office supply information server;

FIG. 4A shows an example of user information stored in a user information storing part;

FIG. 4B shows an example of preference information stored in a preference information storing part;

FIG. 5 shows a flowchart showing the process procedure according to the first embodiment of the present invention;

FIG. 6A shows an example of an advertisement screen that is generated by the office supply information server 1 and is displayed by the image forming apparatus 2₁;

FIG. 6B shows an example of an order screen that is displayed by touching the order button 601 shown in FIG. 6A;

FIG. 7A shows an example of a warning about the remaining amount of a consumable item;

FIG. 7B shows an example of a consumable item order prompt message;

FIG. 8 shows a block diagram of an image forming apparatus using system according to a second embodiment of the present invention;

FIG. 9 shows a flowchart showing the process procedure in the second embodiment;

FIG. 10 shows example information stored in an expansion commodity storage;

FIG. 11 shows a block diagram of an image forming apparatus using system according to a third embodiment of the present invention;

FIG. 12 shows a flowchart showing the process procedure in the third embodiment.

### BEST MODE FOR CARRYING OUT THE INVENTION

The present invention realizes data communications between an image forming apparatus and a server so as to efficiently replenish consumable items used in the image forming apparatus and other supplies and to realize new usage, wherein the image forming apparatus may be a copy machine, a printer, a facsimile, a compound machine including these functions and the like. In the following, preferred embodiments of the present invention are described with reference to figures.

### First Embodiment

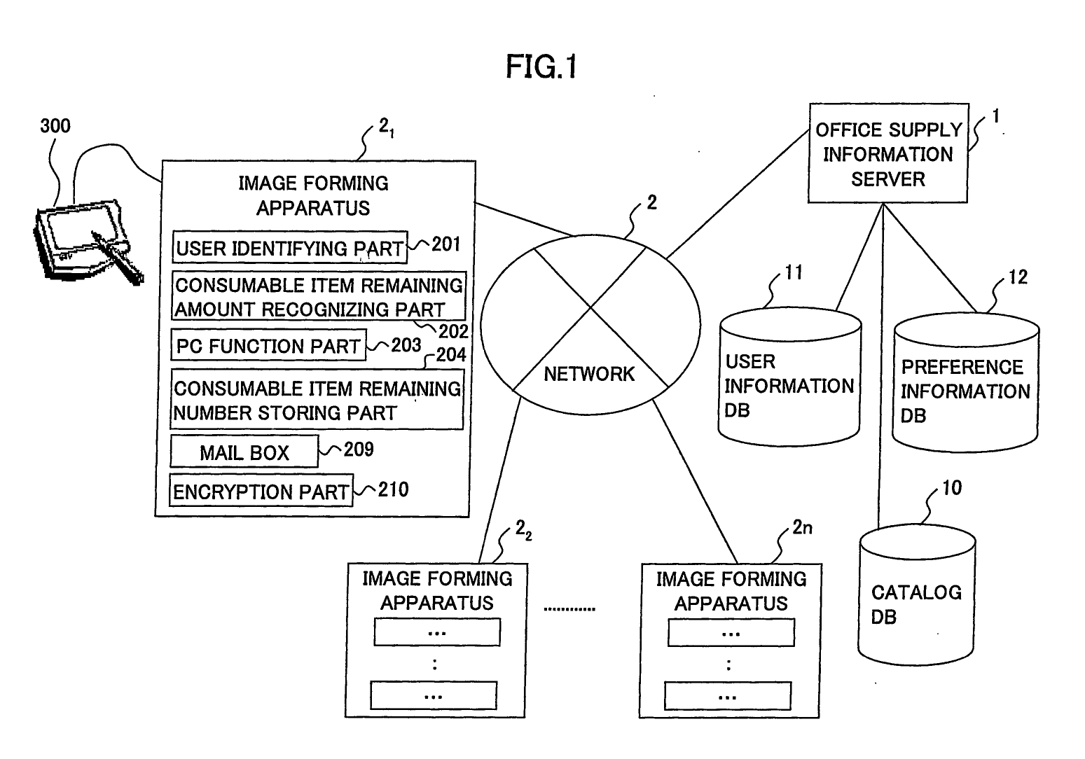

First, a configuration example of the first embodiment of the present invention is described. FIG. 1 is an example of a configuration of an image forming apparatus using system of the first embodiment. As shown in the figure, the image forming apparatus using system includes a plurality of image forming apparatuses 2₁ and an office supply information server 1 that is connected to the image forming apparatuses 2₁ via the network 2. The office supply information server 1 includes a catalog storage 10 that registers commodities managed by the office supply information server 1, a user information storage 11 that includes information such as user's order history and order authority, and a preference information storage 12 that stores user's interests. Each of the image forming apparatuses 2₁ includes a mail box 209, an input and output part 300, a user identifying part 201 for identifying a user that uses the image forming apparatus, and a PC function part 203 that has functions same as a general PC. The office supply information server 1 and the image forming apparatuses 2₁ are connected via the Internet 2 so that these apparatuses can send and receive information each other.

In the following embodiment, communications between the image forming apparatus 2₁ and the office supply information server 1 are preferably performed by using HTTPS (HyperText Transfer Protocol Security) protocol. By using HTTPS, data to be transmitted is encrypted by SSL (Secure Socket Layer) so that the data is hard to be tapped or tampered with by an invalid third party. In addition, in an environment in which a session of the SSL can be established, authentication of the office supply information server 1 can be performed. As to encryption method, IPsec (IP Security) can be also used.

In an environment in which the session of the SSL cannot be established, the data to be transmitted can be encrypted by public key cryptography or symmetric key cryptography. Further, the office supply information server 1 can be authenticated by using an authentication method such as the challenge/response method lest the data is transmitted to a computer other than the office supply information server 1.

[Image Forming Apparatus]

In the following, each function in the image forming apparatus 2₁ is described. The user identifying part 201 is a part for realizing identifying a user who uses the image forming apparatus. Although there are various methods for identifying a user, the user identifying part 201 may adopt any method. For example, the user may be identified by inserting an ID card of the user such as a magnetic card or an IC card into the image forming apparatus. In addition, the image forming apparatus may identify the user by receiving a radio wave signal transmitted from an IC tag embedded in the ID card. Further, the image forming apparatus may identify the user by using living body authentication information such as fingerprint, voiceprint and retina that are registered in the image forming apparatus beforehand. By the user identifying part 201, the image forming apparatus 2₁ identifies a user who uses the image forming apparatus 2₁. As a result, the image forming apparatus 2₁ can store information indicating that number of copies made by the user and the time at which the copy was made by the user. In addition, the image forming apparatus 2₁ may automatically provide a copy mode that is frequently used by the user. The consumable item remaining amount recognizing part 202 is a part for realizing a remaining amount of the consumable items in the image forming apparatus. For example, as to toner, the consumable item remaining amount recognizing part 202 recognizes a toner remaining amount on the basis of weight of a toner cartridge or on the basis of a number of copies made. As to ink for inkjet, the remaining amount can be recognized from the number of ejected papers. By the function of the consumable item remaining amount recognizing part 202, new consumable items can be prepared before using up the consumable items in the image forming apparatus.

The PC function part 203 is a part for providing functions same as a personal computer. The PC function part 203 includes a main control part, an input and output control part for controlling input from an input/output device such as a keyboard and controlling output to a display device, a main storage for temporarily storing programs and data, a storage for storing programs and data, and a communication part for controlling communication with the Internet and a LAN (Local Area Network). As an operating system, Windows, UNIX, LINUX and the like can be used, and the operating system can be operated by using GUI (Graphical User Interface).

The input and output device 300 is a man-machine interface for the user, and provides a function for receiving an operation from the user. The input and output device 300 is operable by using a touch panel by which the user can operate the image forming apparatus by touching a screen by using the user's finger or a stylus pen. Also, a keyboard or a mouse can be used.

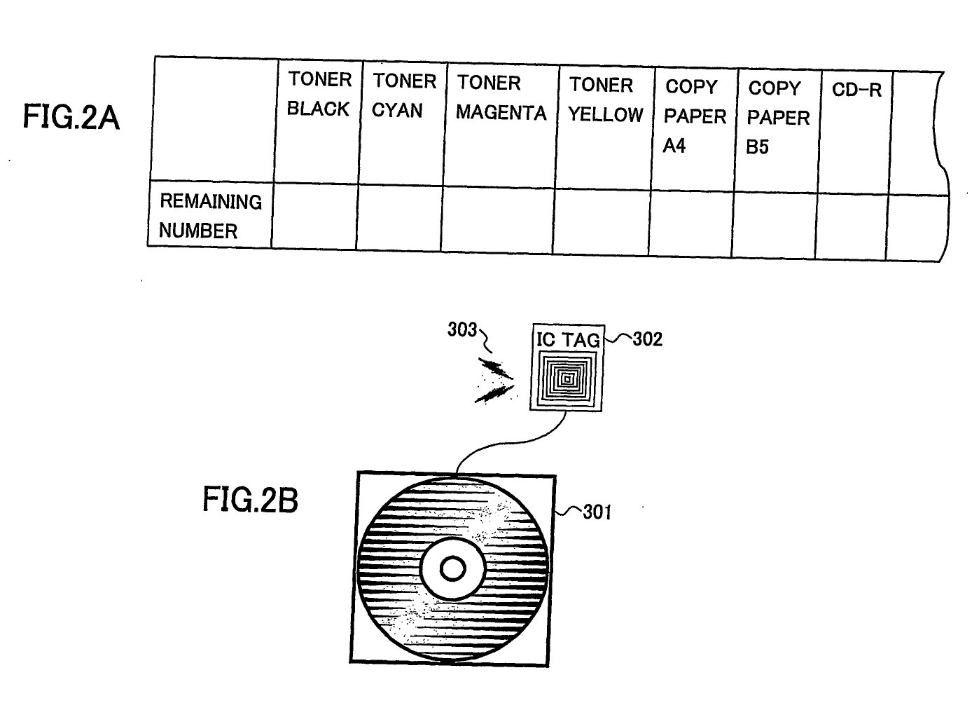

The consumable item remaining number storing part 204 is a part for providing a function for storing a remaining number of a plurality of kinds of consumable items. FIG. 2A shows an example of stored information in the consumable item remaining number storing part 204. As shown in FIG. 2A, the consumable item remaining number storing part 204 includes storing areas for storing remaining amount of supplies such as toners of each color and CD-R. For example, as shown in FIG. 2B, when a CD-R 301 is purchased, an antenna provided in a predetermined place receives a radio wave signal 303 transmitted from an IC tag 302 attached to the CD-R 301, so that the image forming apparatus increments the number of the remaining stock. Instead of using the IC tag, the purchase information can be input by optically reading a barcode, or the purchaser may input the information manually.

The mail box 209 provides storage areas for each user who uses the image forming apparatus. For example, the mail box 209 stores information sent from the office supply information server 1 to each user. When the user uses the image forming apparatus, the image forming apparatus reads information from the mail box 209 and displays the information.

The encryption part 210 encrypts or decrypts information by SSL when the image forming apparatus sends information to the office supply information server 1 or receives information from the office supply information server 1.

The image forming apparatus has an ID unique for the image forming apparatus. The image forming apparatus sends order information of consumable items to the office supply information server 1 with the ID so that the office supply information server 1 can identify the image forming apparatus. If the image forming apparatus is identified, a company and a section where the image forming apparatus is placed can be identified.

[Office Supply Information Server 1]

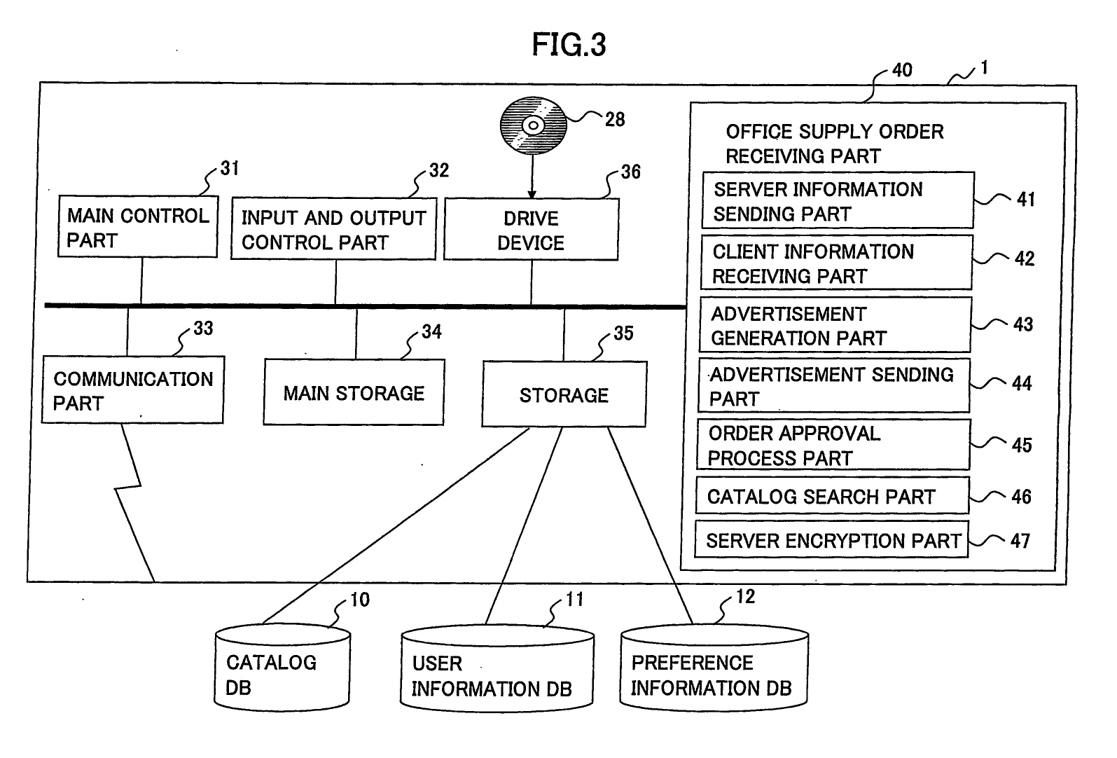

Next, functions of the office supply information server 1 are described with reference to FIG. 3. FIG. 3 shows functional block diagram indicating functions of the office supply information server 1. The office supply information server 1 shown in FIG. 3 includes, like a general computer, a main control part 31 for generally controlling functions of the server, an input and output control part 32 for controlling input from an input/output device such as a keyboard and output to a display device, a main storage 34 for temporarily storing programs and data, a storage 35 for storing programs and data, and a communication part 33 for controlling communication with the Internet and LAN (Local Area Network), and a drive device 36 for reading programs and data from a recording medium 28. As shown in FIG. 1, the storage 35 includes a catalog storage 10 that registers commodities managed by the office supply information server 1, a user information storage 11 and a preference information storage 12.

The recording medium 28 stores an office supply order receiving program that provides each function of the office supply information server. The recording medium 28 is set in the drive device 36, so that the office supply order receiving program is installed in the storage 35 via the drive device 36. The recording medium storing the office supply order receiving program may be a recording medium that stores data electrically or magnetically such as a CD-ROM, a flexible disk, a magneto-optical disk, or a semiconductor memory that stores data electrically such as a ROM, flash memory and the like, or may be one of other various types of recording mediums.

The office supply order receiving part 40 that receives an order of consumable items or other supplies includes a server information sending part 41 for sending information from the office supply information server 1 via the communication part 33, a client information receiving part 42 for receiving information from the image forming apparatus 21, an advertisement generation part 43 for generating an advertisement for each user on the basis of order history of each user, an advertisement sending part for sending the advertisement generated in the advertisement generation part 43, an order approval process part 45 for processing the order from the image forming apparatus 2₁, a catalog search part 46 for searching the catalog storage 10, a server encryption part 47 for encrypting information to be transmitted. In the following, each part of the office supply order receiving part 40 is described.

[Server Information Sending Part 41]

The server information sending part 41 provides a function for sending information to a particular image forming apparatus or to a plurality of image forming apparatuses. The server information sending part 41 may send information in various ways. For example, when sending information via the Internet, the server information sending part 41 specifies an image forming apparatus to which the information needs to be transmitted, so that the server information sending part 41 sends a mail including the information to a mail address of the image forming apparatus in which a user ID and the like for specifying the user which uses the image forming apparatus is added to the mail. Accordingly, the office supply information server can send campaign information and various information for each user.

[Client Information Receiving Part 42]

The client information receiving part 42 is a part for providing a function for receiving information from the image forming apparatus 2₁. The client information receiving part 42 receives data relating to the number of remaining consumable items or the amount of remaining consumable items so that the server can provide the user with proper information. In addition, since the office supply information sever 1 can receive an order of the consumable items directly from the image forming apparatus, the user of the image forming apparatus can order consumable items in a timely manner and without error.

[Advertisement Generation Part 43 and Advertisement Sending Part 44]

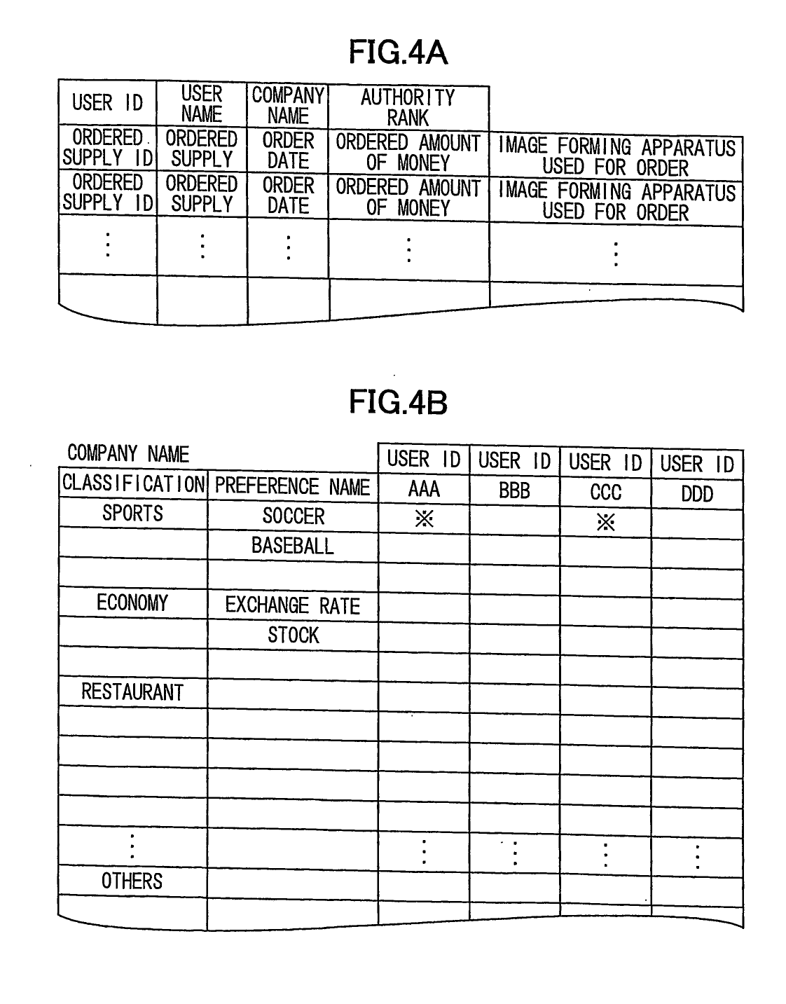

The advertisement generation part 43 is a part for providing a function for generating an advertisement for each user. The generation of each advertisement is performed on the basis of order history and preference information of the user. FIG. 4A shows an example of user information stored in the user information storing part 11. FIG. 4B shows an example of preference information stored in the preference information storing part 12 in FIG. 1.

As shown in FIG. 4A, the user information storing part 11 stores “user ID”, “ordered supply” and the like. The data are stored for each of users even though the users belong to one company. As shown in FIG. 4A, the stored information includes “authority rank” that is used for restricting user's order ability. For example, the authority rank is represented as A, B, C and the like. According to the authority rank, an amount of money that can be used for order for the user can be limited. The authority rank may be the amount of money itself.

As shown in FIG. 4B, the preference information storing part 12 stores company name, user ID, preference information for each user. For example, a file is generated for each company and user's preference fields such as “soccer” and “baseball” are stored.

The advertisement generation part 43 generates an advertisement for each user on the basis of the stored information. For example, after predetermined days expire from a previous ordering date, the advertisement generation part 43 generates campaign information for a supply that was previously ordered. In addition, for example, for a user who is interested in economy such as exchange rate, the advertisement generation part 43 may generate economy information periodically. By providing the advertisement, order of supplies from the image forming apparatus can be encouraged. The generated advertisement is sent to a corresponding user by the advertisement sending part 44. The office supply order receiving part 40 is stored in the storage 35 and is read to the main storage 34 when it is executed.

[Order Approval Process Part 45]

The order approval process part 45 is a part for providing a function for receiving an order from the image forming apparatus 2, and passing order information to an order processing part. When the order approval process part 45 receives an order, the order approval process part 45 refers to an amount of money of the order and the user's authority rank. If the order can be approved on the basis of the user's authority, the order approval process part 45 passes the order information to an order processing part. If the order cannot be approved from lack of the user's authority, the order approval process part 45 sends the order information to a purchase section of the company of the user to obtain approval, for example.

[Catalog Search Part 46]

When an inquiry about a commodity is made from the image forming apparatus 2₁, the catalog search part 46 searches the catalog storage 10 for the commodity to check whether the commodity is included (dealt in). As a result of the search, if the commodity is included in the catalog, the catalog search part 46 checks an amount of stock of the commodity. When the amount of the stock is less than a predetermined amount, replenishing process for the commodity is performed.

[Server Encryption Part 47]

The server encryption part 47 encrypts information to be transmitted by the server information sending part 41 by using SSL and the like, and decrypts information received by the client information receiving part 42. Accordingly, since information communicated between the image forming apparatus 2₁ and the office supply information server 1 is encrypted, tapping and tampering for the information by an invalid third party can be prevented.

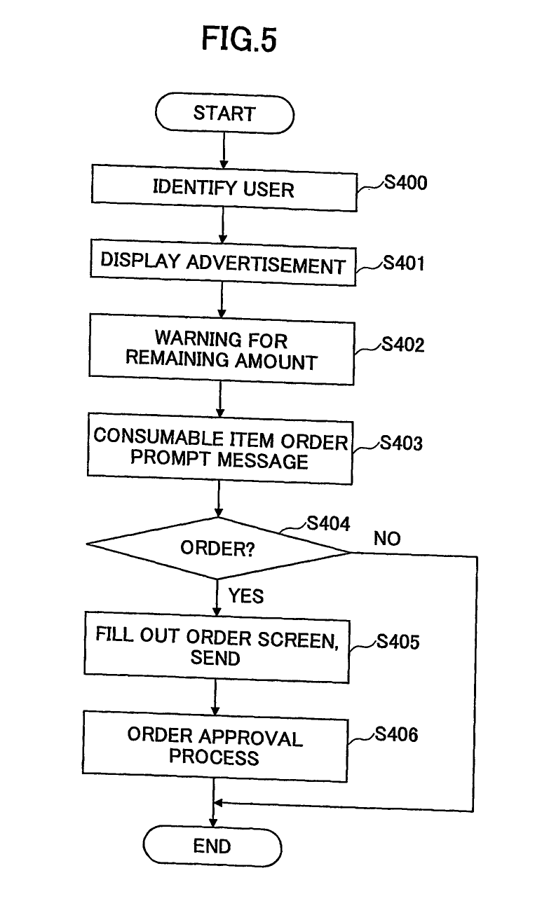

Next, ordering of consumable items by the image forming apparatus is described with reference to a flowchart. FIG. 5 shows a flowchart of the process according to an embodiment of the present invention. First, the user approaches the image forming apparatus 2₁ for using the image forming apparatus 2₁. When the user has an identifying means such as an IC tag that can identify the user regardless of the user's will, the image forming apparatus 2₁ automatically identifies the user. In this case, even if the user does not have any purpose to use the image forming apparatus 2₁, the image forming apparatus 2₁ authenticates the user when the user comes to the image forming apparatus 2₁ within a certain distance in step S400. Alternatively, the image forming apparatus 2₁ may authenticate the user only after the user performs a predetermined operation on the image forming apparatus 2₁.

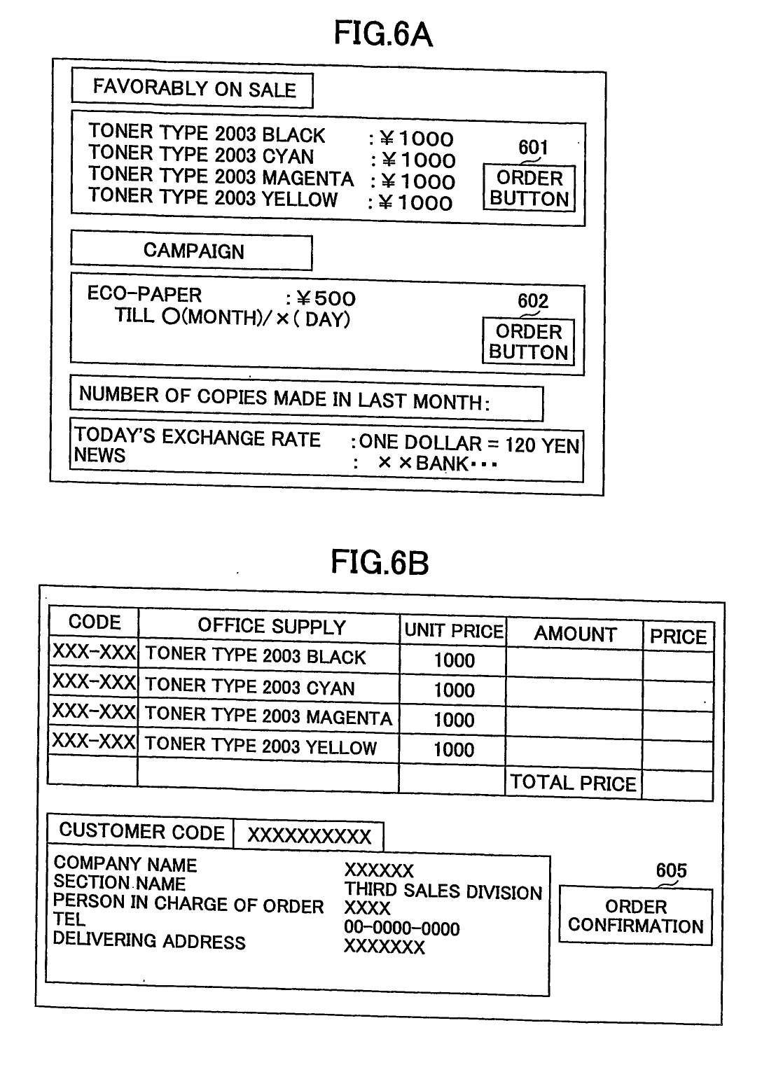

After the user is identified, the image forming apparatus 2₁ checks whether an advertisement exists in an mail box of the user. When the advertisement exists in the mail box, the image forming apparatus 2₁ displays the advertisement in step S401. FIG. 6A shows an example of an advertisement screen that is generated by the office supply information server 1 and is displayed by the image forming apparatus 2₁. In FIG. 6A, commodities determined to have a high possibility of purchase based on the user's past order history are displayed as “favorably on sale”. In addition, a commodity such as a new commodity for which a campaign is being conducted is displayed as “campaign”. In addition, a column in which “today's exchange rate” is displayed is a part of the advertisement generated on the basis of the preference information of the user. As shown in FIG. 6A, the number of copies made each month can be displayed. In addition, circular information in a company can be displayed via the office supply information server 1. Further, a catalog of supplies can be displayed, and advertising information or a catalog can be printed.

In addition, as shown in FIG. 6A, the advertising screen includes order buttons 601 and 602 each corresponding to an advertised supply. Since supplies that fit the needs for the image forming apparatus can be automatically displayed as advertised supplies, the user can select a supply correctly only by touching the order button.

FIG. 6B shows an example of an order screen that is displayed by touching the order button 601 shown in FIG. 6A. The image forming apparatus 2₁ automatically displays codes, office supply names of the codes, and the unit prices. Therefore, the user can complete an order process only by inputting amounts of supplies to be purchased. Although the order screen of supplies shown in FIG. 6B and the advertisement screen of FIG. 6A are provided separately in the present embodiment, the order screen and the advertisement screen can be provided as the same screen. In addition, supplies not shown in the advertisement screen can be displayed on the order screen.

Next, the image forming apparatus 2₁ outputs a warning as to the remaining amount of consumable items used in the image forming apparatus 2₁ if necessary in step S402. As mentioned before, the remaining amount of the consumable items is checked by the consumable item remaining amount recognizing part 202. If the remaining amount is smaller than a predetermined amount, the image forming apparatus 2₁ notifies the office supply information server 1 of the lack of the consumable item.

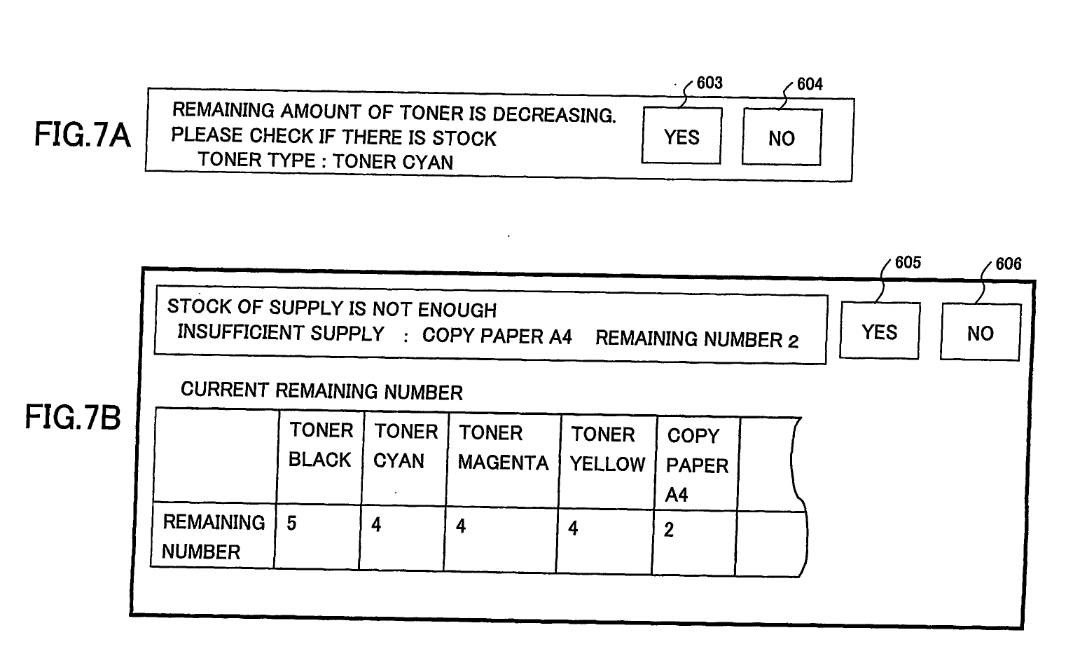

The office supply information server 1 prepares a warning for the remaining amount and sends the warning to the image forming apparatus 2₁ so that the image forming apparatus 2₁ displays the warning. FIG. 7A shows an example of the warning of the remaining amount. As shown in FIG. 7A, for example, if a remaining amount of a toner of cyan is smaller than a predetermined remaining amount, the information shown in FIG. 7A is displayed. Then, an order screen for ordering the supply is displayed by touching “Yes” button 603.

Since the office supply information server 1 is notified of the remaining amount of supplies used in the image forming apparatus 2₁, the office supply information server 1 can estimate a date on which a toner will be changed. Thus, maintenance of the image forming apparatus 2₁ can be performed on the date.

Next, the image forming apparatus 2₁ displays a consumable item order prompt message in step S403 as necessary. A remaining number of consumable items is stored in the consumable item remaining number storing part 204 as mentioned before. The image forming apparatus 2₁ sends the remaining number of consumable items to the office supply information server 1 at predetermined intervals, for example, once a day.

The office supply information server 1 compares each remaining number of consumable items stored in the consumable item remaining number storing part with a corresponding predetermined remaining number of the consumable items that should be kept as predetermined stock. If the actual remaining number is smaller than the predetermined remaining number, the office supply information server 1 sends a consumable item order prompt message to the image forming apparatus 2₁.

FIG. 7B shows an example of the consumable item order prompt message. FIG. 7B shows, as an example, a consumable item order prompt message that prompts the user to place an order of A4 copy papers showing a shortage of the remaining number of the A4 copy papers. In addition, as shown in FIG. 7B, the message may include current remaining number of each supply such that the user can know the numbers. In order to place an order, in the same way shown in FIG. 7A, the user touches “Yes” button 605 so that an order screen of items is displayed.

Although all of the advertisement (step S401), the warning for the remaining amount (step S402) and the consumable item order prompt message (step S403) are displayed in the flowchart of FIG. 5, only the advertisement may be displayed, for example. In addition, any one of them may not be displayed. Further, for example, the warning or the consumable item order prompt message can be displayed only when the image forming apparatus 2₁ recognizes a particular purchaser. In addition, although the advertisement (step S401), the warning for the remaining amount (step S402) and the consumable item order message (step S403) are displayed respectively according to the present embodiment, a screen in which these pieces of information and an advertisement are composed can be displayed as necessary.

When any of the above information is displayed on the screen, there is a high possibility in that a commodity that is displayed on the screen is ordered. Therefore, the office supply information server 1 searches the catalog storage 10 by using the catalog search part shown in FIG. 3 so as to check where there remains the stock of the commodity. If the number of the commodities in the stock is less than a predetermined number, replenishment of the stock is performed. Thus, since replenishment of the stock of an office supply having high possibility to be purchased is started before the user actually order the supply, the time of delivery from order can be decreased even.

In the case where an order is placed subsequently in step S404, as mentioned above, the order screen of FIG. 6B is displayed so that the user inputs predetermined items. After the user inputs the predetermined items for ordering, the user touches the order check button 607 so that the order information is sent to the office supply information server in step S405. At this time, the image forming apparatus 2₁ may output the order information. If the order is not placed, the process ends at step S404.

The office supply information server 1 receives the order information and passes the order information to an order approval process in step S406. The order approval process is performed by the order approval process part 45 shown in before-mentioned FIG. 3. Accordingly, the process shown in the flowchart of FIG. 5 ends.

In the first embodiment, since information can be transmitted between the image forming apparatuses and the office supply information server 1, replenishment of supplies can be performed timely and correctly without using a PC. In addition, information relating to supplies are collected by the office supply information server 1 via the image forming apparatus, various information services can be provided via the image forming apparatus 2₁.

### Second Embodiment

As mentioned above, in the first embodiment, an consumable item can be ordered on the basis of information output from the image forming apparatus in which the information are the advertisement generated by the image forming apparatus, the warning for the remaining amount of the consumable item or the consumable item order prompt message. In a second embodiment described below, an example is described in which the user starts placing of an order.

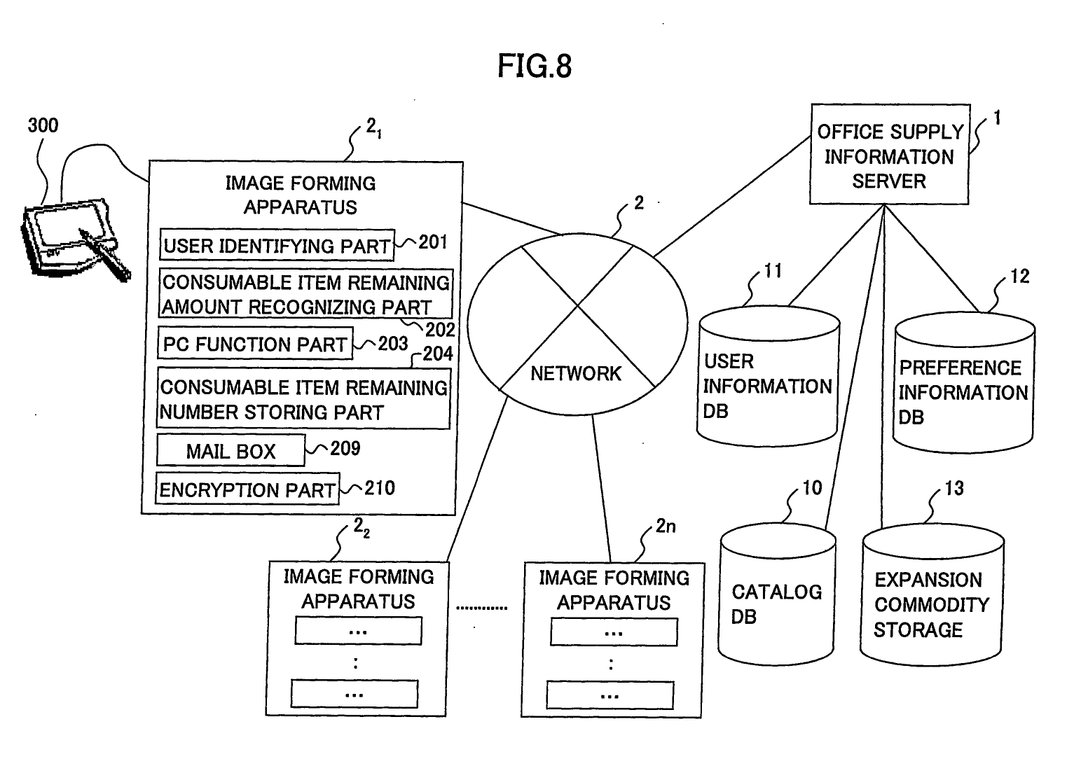

FIG. 8 shows an example of a block diagram of an image forming apparatus using system according to the second embodiment. In the block diagram shown in FIG. 8, the same reference numerals are used to identify corresponding features. The present embodiment is different from the first embodiment in that the office supply information server 1 includes an expansion commodity storage 13 in the present embodiment.

The expansion commodity storage 13 is a storage for storing information of office supplies that a user inquired about but are not dealt in. The expansion commodity storage 13 stores office supplies that may be expanded as commodities to be newly dealt in among office supplies that were inquired about from the image forming apparatus 2₁.

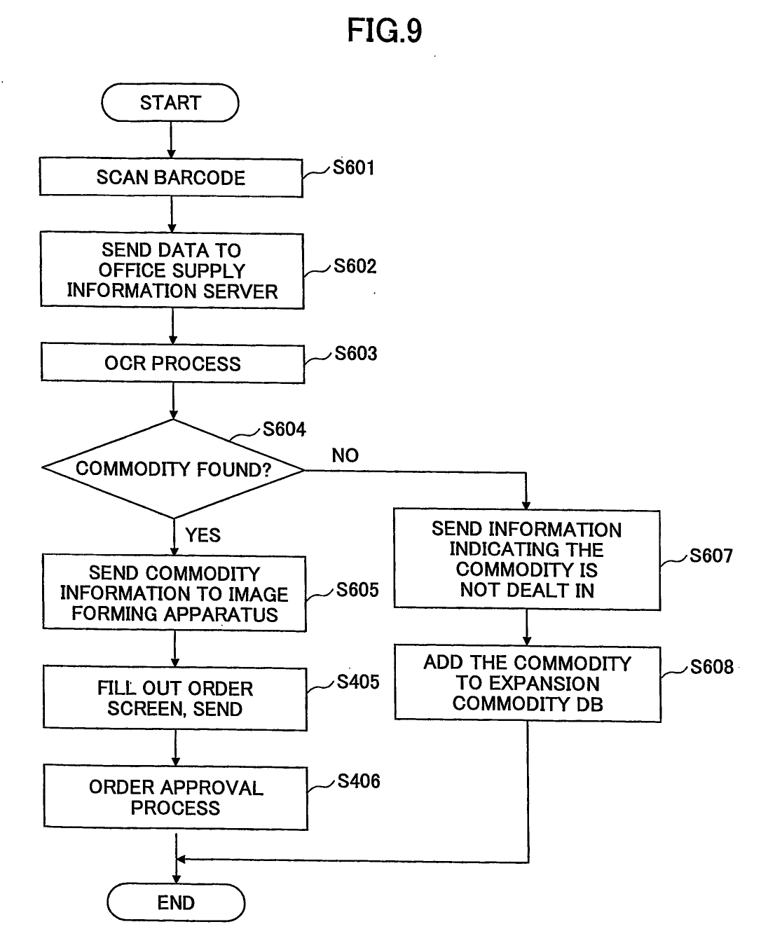

The present embodiment is described with reference to a flowchart of FIG. 9. FIG. 9 shows a flowchart of process procedure in the second embodiment.

First, the user scans a barcode of an office supply by using the image forming apparatus 2₁ in step S601. The barcode of the office supply is a barcode printed or attached on wrapping of copy papers, wrapping or a container of stationery or the like. Since the barcode includes a maker name of the office supply, a commodity code, the price and the like, the office supply can be identified by identifying the barcode.

Next, the image forming apparatus 2₁ sends the barcode scanned in step S601 to the office supply information server 1 in step S602.

Since the barcode scanned in step S601 is image data, information embedded in the barcode cannot be used from the image data as it is. In addition, the scanned data include information other than the barcode such as the commodity name printed on wrapping of the copy papers.

Thus, the office supply information sever 1 that received the image data including the barcode performs processes for recognizing the barcode region and processes of OCR (optical character reader) in step S603. The region of the barcode is recognized as a region in which straight lines of different thickness are arraigned at irregular intervals. In addition, by performing OCR processes, the thickness of the lines and the intervals are recognized so that information such as the maker name, the commodity code, price and the like embedded in the barcode can be used. Barcode data is generated from the barcode by the OCR process.

The process of step S603 may be performed by the image forming apparatus 2₁. When the process of step S603 is performed by the image forming apparatus 2₁, the amount of data to be transmitted to the office supply information server 1 decreases so that the data can be sent in shorter time.

Next, the office supply information server 1 searches for a commodity corresponding to the barcode data by using the catalog search part 46 in step S604. At this time, the office supply information server 1 refers to the number of commodities in stock. If the number is smaller than a predetermined number, the office supply information server 1 performs replenishment process for the stock of the commodity. Accordingly, since replenishment of the stock of an office supply having high possibility to be purchased is started before the user actually orders the supply, the time of delivery from order can be decreased even if the amount of the stock is not enough.

If the corresponding commodity data is searched for in step S604, the office supply information server 1 sends a formal name, a manufacturer name, a date of delivery, a price and the like for the commodity to the image forming apparatus 2₁ in step S605. In addition to the above-mentioned information, the office supply information server 1 may send information of another commodity having the same function as that of the above commodity corresponding to the barcode data. For example, the office supply information server 1 sends information of a copy paper of different manufacturer in addition to the searched one. Accordingly, the range of selection can be increased for the user.

The image forming apparatus 2₁ receives the information sent in step S605 from the office supply information server 1, and displays the information on the touch panel 300. After that, processes shown as steps S405 and S406 in the flowchart of FIG. 5 are performed.

If the commodity data corresponding to the barcode is not searched for in step S604, the process goes to step S607. Then, the office supply information server 1 sends information indicating that the commodity is not dealt in to the image forming apparatus 2₁ in step S607. Also at this time, the office supply information server 1 may send information of another commodity having the same function as that of the above commodity corresponding to the barcode data. For example, the office supply information server 1 sends information of a copy paper of a manufacturer different from the commodity corresponding to the barcode data. Accordingly, the range of selection can be increased for the user. In addition, there is a merit in that the another commodity may be purchased even if the commodity corresponding to the barcode is not dealt in.

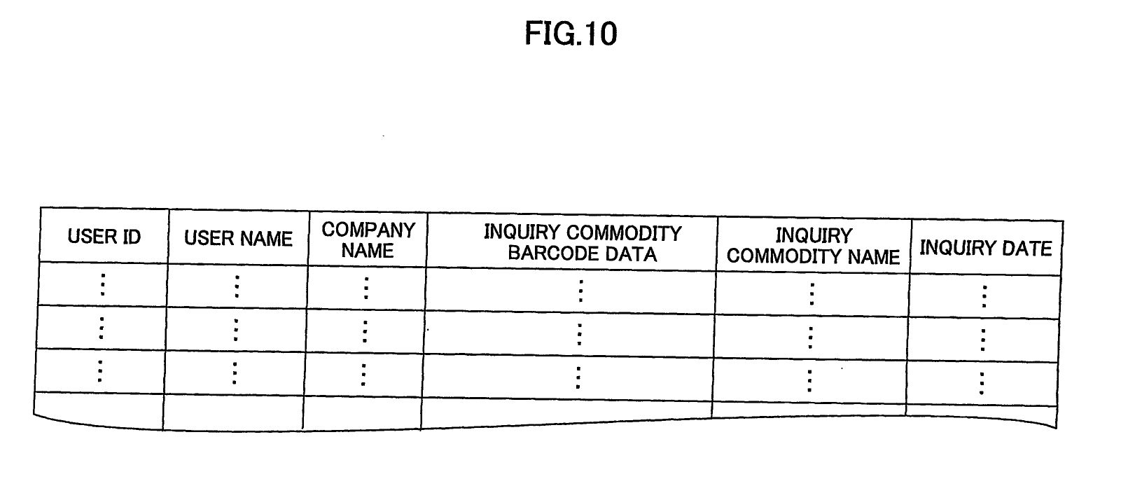

When the commodity corresponding to the barcode is one that is not dealt in, the commodity is stored in the expansion commodity storage 13 in step S608. FIG. 10 shows an example of the information stored in the expansion commodity storage 13. The information stored in the expansion commodity storage 13 includes “user ID”, “user name”, “company name”, “inquired commodity barcode data”, “inquired commodity name” and “date of inquiry”. As mentioned before, the expansion commodity storage 13 is a storage for storing information of office supplies that a user inquired about but are not dealt in. Since various inquiry data are collected by the office supply information server 1, a commodity that receives many inquiries quickly starts to be dealt in. After that, the processes of the flowchart of FIG. 9 ends.

Although a commodity is identified by scanning the barcode in the present embodiment, the commodity can be identified by a radio wave signal transmitted from an IC tag, or the commodity can be identified by inputting the name of the commodity by the user for inquiring about the commodity.

According to the above-mentioned embodiment, the user can easily inquire about a commodity and an expansion of the commodity can be performed based on the inquiry. Thus, user's convenience increases.

### Third Embodiment

The first and second embodiments provided examples about supplies by using the image forming apparatus 2, and the office supply information server 1. In the third embodiment, an image forming apparatus using system in which a plurality of image forming apparatuses are used is described.

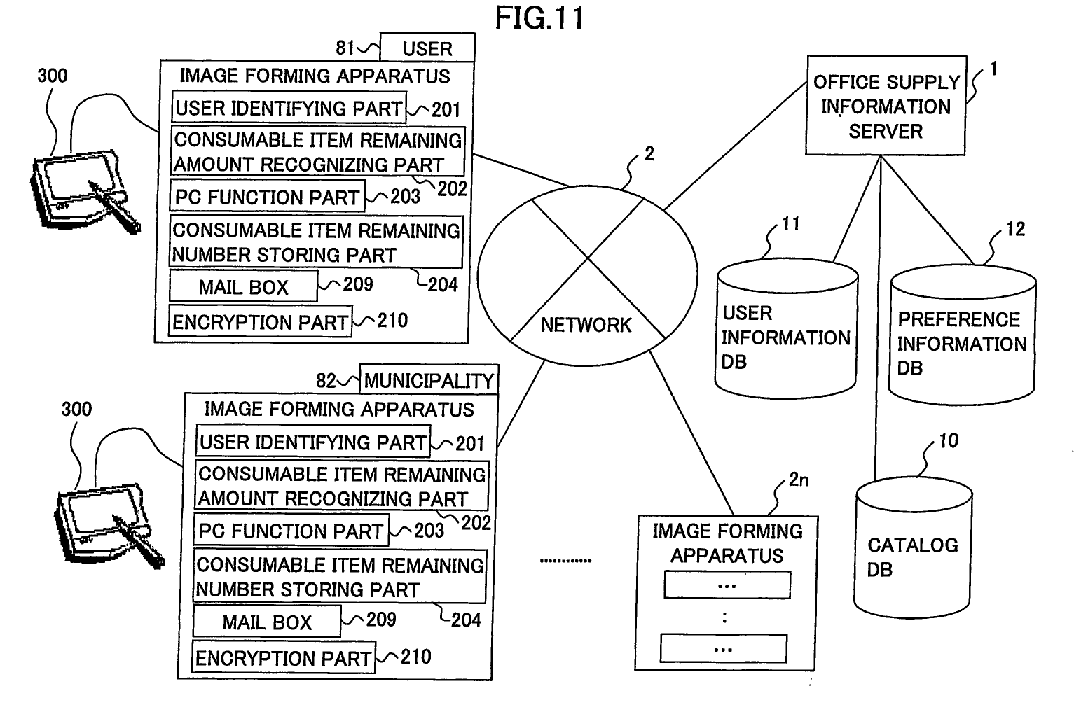

FIG. 11 is a block diagram of the image forming apparatus using system of the third embodiment. In the block diagram shown in FIG. 11, the same reference numerals are used to identify corresponding features.

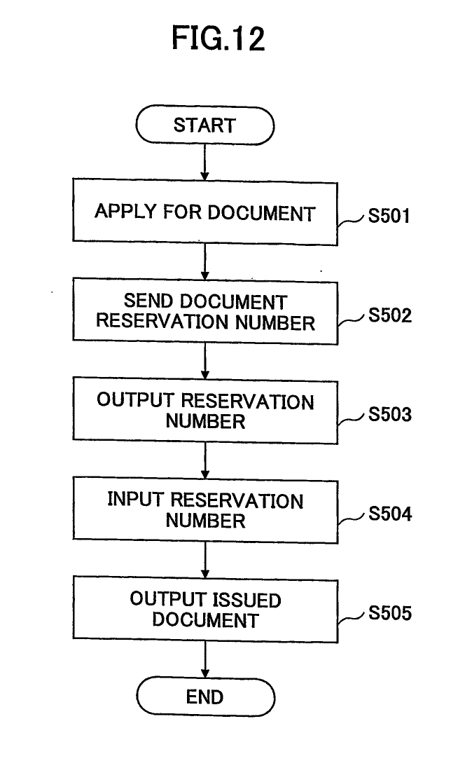

In the present embodiment, as shown in FIG. 11, the image forming apparatus 81 exists in a company, for example, to which the user belongs. The image forming apparatus 82 exists in a municipality. The present embodiment is described with reference to a flowchart of FIG. 12. FIG. 12 is a flowchart showing processes of the third embodiment.

First, the user requests the municipality to issue a document by using the image forming apparatus 81 in step S501. For example, for applying for a resident's card, the user selects a ward office or a branch of the ward office where the user will receive the resident's card. The image forming apparatus 81 may refer to an address of the user and the like by using the user identifying part 201 so as to show municipalities having a high possibility in that the user receives the resident's card. Alternatively, the image forming apparatus 81 may show municipalities near the image forming apparatus 81. A municipality that is one selected is stored in the mail box 209 as personal information of the user.

The application information is sent to the office supply information server 1 from the image forming apparatus 81 in step S502. The office supply information server 1 identifies an image forming apparatus 82 that exists in an municipality specified by the user, and the office supply information server 1 sends reservation information to the image forming apparatus 82. The reservation information includes the user's date of birth and the like that are necessary for applying for the resident's card. The reservation information is identified by a reservation number.

The municipality can prepare the user's resident's card in advance before the user comes to the municipality. The information of the prepared resident's card is stored in a predetermined storage area such as the mail box 209 in the image forming apparatus 82 such that the information can be output from the image forming apparatus 82. Alternatively, the information of the resident's card may be stored in a PC of the municipality.

The reservation number is sent not only to the image forming apparatus 82 but also to the image forming apparatus 81. The reservation number is output from the image forming apparatus 81. Thus, the user can obtain the resident's card on the basis of the reservation number that is displayed or output by the image forming apparatus 81.

The user who obtains the reservation number goes to the municipality in which the image forming apparatus 82 exists, and inputs the reservation number into the image forming apparatus 82 in step S504. Alternatively, the user may hand the reservation number to a person in the municipality so that the person input the reservation number into the image forming apparatus 82.

Next, the image forming apparatus 82 outputs the user's resident's card on the basis of the input reservation number in step S505. The user pays a fee for issuing the document from a cash slot that is installed near the image forming apparatus 82, for example. Alternatively, an image forming apparatus in the same municipality other than the image forming apparatus 82 that receives the reservation number may output the resident's card, and the user may pay a fee to the municipality in exchange for the resident's card.

According to the present embodiment, the resident's card can be prepared in advance so that congestion in the municipality can be relieved. In addition to the resident's card, the present embodiment can be also applied to various documents issued by the municipality such as a copy of one's family register, an identification card and the like.

The present embodiment can be applied to various cases. For example, the present embodiment can be applied in a library. For example, as to making a copy of a book, a magazine, a newspaper and the like in the library for a user, a work load in the library can be decreased by receiving an application beforehand.

As mentioned above, the present invention provides an image forming apparatus using system including at least one image forming apparatus having a touch panel and an office supply information server that is connected to the image forming apparatuses via a network, the image forming apparatus including: a client information sending part for sending order information to the office supply information server; and a server information receiving part for receiving information from the office supply information server, the office supply information server including: a server information sending part for sending information to the image forming apparatus; and a client information receiving part for receiving information input from the touch panel of the image forming apparatus, wherein the image forming apparatus orders an office supply from the office supply information server by using the client information sending part.

The image forming apparatus may further includes a user identifying part for identifying a user when the user uses the image forming apparatus. Thus, a proper image forming apparatus using system can be provided for each user. In the image forming apparatus using system, the office supply includes an IC chip by which the office supply can be identified, and the IC chip includes an identification information sending part for sending identification information of the office supply to the image forming apparatus by radio, and the image forming apparatus further includes: a counting part for counting the number of remaining supplies based on the identification information sent from each IC chip; and a part for sending the number of the remaining supplies to the office supply information server, wherein the office supply information server sends a supply order prompt message for prompting the user to order the supply to the image forming apparatus when the remaining number is smaller than a predetermined number for the supply. According to this configuration, since the image forming apparatus automatically count the remaining number of the office supplies, and placing an order is prompted if the remaining number is smaller than a predetermined number. Thus, delay of replenishment of office supplies can be avoided. The office supply includes a consumable item such as toner and copy papers. An amount of consumable item is decreased if the consumable item is used. The office supply such as the consumable item is not limited to one used in the image forming apparatus. For example, a spare lead of an automatic pencil is included as an office supply.

In the image forming apparatus using system, the office supply information server may further includes: a user information storing part for storing order history of each user; a preference information storing part for storing preference information of each user; an advertisement generation part for generating an advertisement to be sent to each user on the basis of the order history and the preference information; and an advertisement sending part for sending the advertisement to the image forming apparatus. Accordingly, since an advertisement based on the user's past order history and the user's preferences can be sent, replenishment of office supplies can be performed properly.

In the image forming apparatus using system, the image forming apparatus may further include: a supply remaining amount sending part for sending, to the office supply information server, data of a remaining amount of the supply in the image forming apparatus, wherein the office supply information server sends a warning relating to the remaining amount to the image forming apparatus when the received remaining amount is smaller than a predetermined amount. Since a warning is displayed before an office supply is used up, an office supply can be replenished properly.

In the image forming apparatus using system, the image forming apparatus may further includes; a scanning part for scanning a barcode of the supply; and a barcode sending part for sending information of the barcode to the office supply information server, and the office supply information server may further includes: a search part for searching for an office supply corresponding to the barcode by using the information of the barcode, wherein the office supply information server sends information of the office supply to the image forming apparatus if the office supply is found from the information of the barcode, and the office supply information server registers the information of the office supply in an expansion commodity storage as a commodity to be newly dealt in if the office supply is not found from the information of the barcode. The image forming apparatus can display an order screen for ordering office supplies in addition to displaying a supply order prompt message, an advertisement, a warning or the information of the supply corresponding to the barcode, and the image forming apparatus sends information input from the order screen to the office supply information sever so that the office supplies are ordered. According to this configuration, an order form is attached to the supply order prompt message, the advertisement, the warning or the information of the supply corresponding to the barcode, so that the user can place an order of an office supply by filling out the order form and sending it to the server. Thus, an order of an office supply can be placed easily and correctly. The order screen may be displayed on the image forming apparatus as a screen different from a screen showing the supply order prompt message, the advertisement, the warning or the information of the supply corresponding to the barcode. Thus, display screens relating to office supplies can be configured flexibly.

The image forming apparatus may output the order information input from the order screen as a facsimile format so that the office supply is ordered by facsimile. Since the facsimile format is used, the user can visually check the information and record the order information by using papers.

The office supply information server may refer to an amount of money stored in the user information storing part wherein the amount of money is a limit amount usable by the user for ordering office supplies, and if an amount of money necessary for purchasing the office supplies ordered from the image forming apparatus by the user is smaller than the limit amount of money, the image forming apparatus performs an approval process. By this configuration, an order exceeding user's authority can be prevented from being placed.

In addition, the present invention provides an image forming apparatus using system including a first image forming apparatus placed in a user's site, a second image forming apparatus placed in a municipality, and an office supply information server that is connected to the first and second image forming apparatuses, wherein: the first image forming apparatus applies for a document by sending application information to the office supply information server; the office supply information server sends a document reservation number to the first image forming apparatus on the basis of the application information; the first image forming apparatus outputs the document reservation number; and the second image forming apparatus outputs the document on the basis of the document reservation number input by the user. According to this system, since the user can apply for a document issued by a municipality by using the user's image forming apparatus, the user can conveniently receive the document. In addition, the present invention provides the above-mentioned office supply information server. The office supply information server may further includes: a stock management part for managing stock of office supplies, wherein the stock management part performs stock management on the basis of information of an office supply relating to the supply order prompt message, information of an office supply relating to the warning, or the information of the barcode. According to this configuration, replenishment of a commodity having high possibility of being ordered can be performed beforehand, stock management can be performed efficiently and the date of delivery can be decreased.

The present application contains subject matter related to Japanese patent application No. 2003-162618, filed in the JPO on Jun. 6, 2003, and Japanese patent application No. 2004-124319, filed in the JPO on Apr. 20, 2004, the entire contents of which being incorporated herein by reference.

The present invention is not limited to the specifically disclosed embodiments, and variations and modifications may be made without departing from the scope of the invention.

1. An image forming apparatus using system including at least one image forming apparatus having a touch panel and an office supply information server that is connected to the image forming apparatuses via a network,
the image forming apparatus comprising:
a client information sending part for sending order information to the office supply information server; and
a server information receiving part for receiving information from the office supply information server,
the office supply information server comprising:
a server information sending part for sending information to the image forming apparatus; and
a client information receiving part for receiving information input from the touch panel of the image forming apparatus,
wherein the image forming apparatus orders an office supply from the office supply information server by using the client information sending part.

2. The image forming apparatus using system as claimed in claim 1, the image forming apparatus further comprising a user identifying part for identifying a user when the user uses the image forming apparatus.

3. The image forming apparatus using system as claimed in claim 1, the image forming apparatus further comprising an operating system that provides a graphical user interface by which the user operates the image forming apparatus on the touch panel.

4. The image forming apparatus using system as claimed in claim 1, wherein the office supply includes an IC chip by which the office supply can be identified, and the IC chip includes an identification information sending part for sending identification information of the office supply to the image forming apparatus by radio,
the image forming apparatus further comprising:
a counting part for counting the number of remaining supplies based on the identification information sent from each IC chip; and
a part for sending the number of the remaining supplies to the office supply information server,
wherein the office supply information server sends a supply order prompt message for prompting the user to order the supply to the image forming apparatus when the remaining number is smaller than a predetermined number for the supply.

5. The image forming apparatus using system as claimed in claim 1, the office supply information server further comprising:
a user information storing part for storing order history of each user;
a preference information storing part for storing preference information of each user;
an advertisement generation part for generating an advertisement to be sent to each user on the basis of the order history and the preference information; and
an advertisement sending part for sending the advertisement to the image forming apparatus.

6. The image forming apparatus using system as claimed in claim 1, the image forming apparatus further comprising:
a supply remaining amount sending part for sending, to the office supply information server, data of a remaining amount of the supply in the image forming apparatus,
wherein the office supply information server sends a warning relating to the remaining amount to the image forming apparatus when the received remaining amount is smaller than a predetermined amount.

7. The image forming apparatus using system as claimed in claim 1, the image forming apparatus further comprising;
a scanning part for scanning a barcode of the supply; and
a barcode sending part for sending information of the barcode to the office supply information server,
the office supply information server further comprising:
a search part for searching for an office supply corresponding to the barcode by using the information of the barcode,
wherein the office supply information server sends information of the office supply to the image forming apparatus if the office supply is found from the information of the barcode, and the office supply information server registers the information of the office supply in an expansion commodity storage as a commodity to be newly dealt in if the office supply is not found from the information of the barcode.

8. The image forming apparatus using system as claimed in claim 4, wherein the image forming apparatus displays an order screen

8. The image forming apparatus using system as claimed in claim 4, wherein the image forming apparatus displays an order screen for ordering office supplies in addition to displaying a supply order prompt message, an advertisement, a warning or the information of the supply corresponding to the barcode, and
the image forming apparatus sends information input from the order screen to the office supply information sever so that the office supplies are ordered.

9. The image forming apparatus using system as claimed in claim 8, wherein the order screen is displayed on the image forming apparatus as a screen different from a screen showing the supply order prompt message, the advertisement, the warning or the information of the supply corresponding to the barcode.

10. The image forming apparatus using system as claimed in claim 8, wherein the image forming apparatus outputs the order information input from the order screen as a facsimile format so that the office supply is ordered by facsimile.

11. The image forming apparatus using system as claimed in claim 2, wherein the office supply information server refers to an amount of money stored in the user information storing part wherein the amount of money is a limit amount usable by the user for ordering office supplies, and
if an amount of money necessary for purchasing the office supplies ordered from the image forming apparatus by the user is smaller than the limit amount of money, the image forming apparatus performs an approval process.

12. An image forming apparatus using system including a first image forming apparatus placed in a user's site, a second image forming apparatus placed in a municipality, and an office supply information server that is connected to the first and second image forming apparatuses, wherein:
the first image forming apparatus applies for a document by sending application information to the office supply information server;
the office supply information server sends a document reservation number to the first image forming apparatus on the basis of the application information;
the first image forming apparatus outputs the document reservation number; and
the second image forming apparatus outputs the document on the basis of the document reservation number input by the user.

13. An office supply information server that is connected to at least one image forming apparatus having a touch panel via a network, the office supply information server comprising:
a server information sending part for sending information to the image forming apparatus; and
a client information receiving part for receiving information input from the touch panel of the image forming apparatus.

14. The office supply information server as claimed in claim 13, the office supply information server further comprising:
a user information storing part for storing order history of each user;
a preference information storing part for storing preference information of each user;
an advertisement generation part for generating an advertisement to be sent to each user on the basis of the order history and the preference information; and
an advertisement sending part for sending the advertisement to the image forming apparatus.

15. The office supply information server as claimed in claim 13, wherein the office supply information server receives a number of remaining office supplies in the image forming apparatus, and
the office supply information server sends a supply order prompt message for prompting a user of the image forming apparatus to order the office supply to the image forming apparatus when the remaining number is smaller than a predetermined number for the office supply.

16. The office supply information server as claimed in claim 13, wherein the office supply information server receives data of a remaining amount of an office supply in the image forming apparatus, and
the office supply information server sends a warning relating to the remaining amount to the image forming apparatus when the received remaining amount is smaller than a predetermined amount.

17. The office supply information server as claimed in claim 13, the office supply information server further comprising:
a search part for receiving information of a barcode from the image forming apparatus, and searching for an office supply corresponding to the barcode by using the information of the barcode,
wherein the office supply information server sends information of the office supply to the image forming apparatus if the office supply is found from the information of the barcode, and the office supply information server registers the information of the office supply in an expansion commodity storage as a commodity to be newly dealt in if the office supply is not found from the information of the barcode.

18. The office supply information server as claimed in claim 13, wherein the office supply information server refers to an amount of money stored in the user information storing part wherein the amount of money is a limit amount usable by a user for ordering office supplies, and
if an amount of money necessary for purchasing office supplies ordered from the image forming apparatus by the user is smaller than the limit amount of money, the image forming apparatus performs an approval process.

19. The office supply information server as claimed in claim 15, the office supply information server further comprising:
a stock management part for managing stock of office supplies, wherein the stock management part performs stock management on the basis of information of an office supply relating to the supply order prompt message, information of an office supply relating to the warning, or the information of the barcode.
